(19) United States
(12) Patent Application Publication
(10) Pub. No.: US 2006/0243381 A1
(43) Pub. Date: Nov. 2, 2006

(54) Method Of Treating Nozzle Plate

(75) Inventors: Atsushi Ito, Nagoya-shi, Aichi-ken (JP); Seiko Kitahara, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/380,565

(22) Filed: Apr. 27, 2006

(30) Foreign Application Priority Data
Apr. 27, 2005 (JP) 2005129061

(51) Int. Cl. B32B 37/00; B32B 38/00

(52) U.S. Cl. 156/275.5; 156/285

(57) ABSTRACT

A method of treating a nozzle plate having at least one nozzle hole which is formed through a thickness thereof, and an ejection surface in which one of opposite open ends of the nozzle hole opens. A droplet of a liquid is ejected from the one open end of the nozzle hole. The method comprises providing, on the ejection surface of the nozzle plate, a layer of a photo-curing resin, such that the layer of the photo-curing resin closes at least the one open end of the nozzle hole, pressing, in a state in which a pressure of a gas in an ambient space around the nozzle plate is lower than an atmospheric pressure, the layer of the photo-curing resin against the nozzle plate, and causing a first portion of the photo-curing resin to be pushed into one of opposite end portions of the nozzle hole through the one open end thereof irradiating, with a light through an other of the opposite end portions of the nozzle hole, the first portion of the photo-curing resin pushed in the one end portion of the nozzle hole, and a second portion of the photo-curing resin that is continuous with the first portion and is aligned with, and located outside, the one open end of the nozzle hole, so as to cure the first and second portions, removing an uncured, remaining portion of the photo-curing resin so as to expose the ejection surface of the nozzle plate such that the cured first and second portions of the photo-curing resin are held by the nozzle hole, and forming a water-repellent layer on the exposed ejection surface of the nozzle plate.

The present application is based on Japanese Patent Application No. 2005-129061 filed on Apr. 27, 2005, the contents of which are incorporated herein by reference.

### BACKGROUND OF THE INVENTION

1. Field of the Invention

The present invention relates to a method of treating a nozzle plate having one or more nozzle holes each of which ejects a droplet of a liquid such as an ink.

2. Discussion of Related Art

Japanese Patent Application Publication No. 6-246921 or its corresponding U.S. Pat. No. 5,863371A or U.S. Pat. No. 6,390,599B1 discloses a method of treating an outer surface of a nozzle plate having a plurality of nozzle holes. In this treating method, first, a photo-curing-resin film is laminated on the outer surface of the nozzle plate, and then the photo-curing-resin film is pressed against the nozzle plate while the photo-curing resin is heated up to a temperature not lower than a glass transition point thereof. Thus, respective portions of the photo-curing resin are pushed into the nozzle holes. Subsequently, an opposite surface of the nozzle plate is irradiated with an ultraviolet light, so as to set or cure the: respective portions of the photo-curing resin that are pushed in the nozzle holes and thereby form respective closure portions that close the nozzle holes. Then, the uncured, remaining portion of the photo-curing resin other than the closure portions is entirely removed from the outer surface of the nozzle plate, and a plating layer is formed on the outer surface of the nozzle plate by using the closure portions as a template. Thus, a water-repellent layer is formed on the outer surface of the nozzle plate.

### SUMMARY OF THE INVENTION

However, in the treating method disclosed by the above-identified prior art, since the photo-curing resin is heated for the purpose of pushing the respective portions thereof into the nozzle holes, air bubbles are produced in the resin. If those air bubbles remain around the boundaries between the closure portions and the nozzle holes, then respective shapes of the closure portions corresponding to the nozzle holes more or less vary from each other. If the respective shapes of the closure portions vary from each other, then respective shapes of respective portions of the plating layer that are located around the nozzle holes also vary from each other, which leads to deflecting directions in which droplets of ink are ejected from the nozzle holes. In addition, when the photo-curing resin is heated up to the temperature higher than the glass transition point thereof, then the nozzle plate is also heated. Consequently, the nozzle plate is warped because of the difference of respective thermal contraction coefficients of the nozzle plate and the photo-curing resin.

It is therefore an object of the present invention to solve at least one of the above-indicated problems. It is another object of the present invention to provide a method of treating a nozzle plate that is free of the problem that the direction of ejection of liquid droplets is deflected because of the air bubbles produced when a water-repellent layer is formed on an outer surface of the nozzle plate and/or the problem that the nozzle plate is warped.

The above objects may be achieved according to the present invention. According to a first aspect of the present invention, there is provided a method of treating a nozzle plate having at least one nozzle hole which is formed through a thickness thereof, and an ejection surface in which one of opposite open ends of the at least one nozzle hole opens. A droplet of a liquid is ejected from the one open end of the at least one nozzle hole. The method comprises providing, on the ejection surface of the nozzle plate, a layer of a photo-curing resin, such that the layer of the photo-curing resin closes at least the one open end of the at least one nozzle hole, pressing, in a state in which a pressure of a gas in an ambient space around the nozzle plate is lower than an atmospheric pressure, the layer of the photo-curing resin against the nozzle plate, and causing a first portion of the photo-curing resin to be pushed into one of opposite end portions of the at least one nozzle hole through the one open end thereof, irradiating, with a light through an other of the opposite end portions of the at least one nozzle hole, the first portion of the photo-curing resin pushed in the one end portion of the at least one nozzle hole, and a second portion of the photo-curing resin that is continuous with the first portion thereof and is aligned with, and located outside, the one open end of the at least one nozzle hole, so as to cure the first and second portions, removing an uncured, remaining portion of the photo-curing resin so as to expose the ejection surface of the nozzle plate such that the cured first and second portions of the photo-curing resin are held by the at least one nozzle hole, and forming a water-repellent layer on the exposed ejection surface of the nozzle plate.

In the present treating method, the first portion of the photo-curing resin is pushed into the one end portion of the nozzle hole, in the ambient space whose gas pressure is lower than the atmospheric pressure. Since the glass transition temperature of the photo-curing resin lowers as the gas pressure of the ambient space lowers, the photo-curing resin can be made softer without being heated, and the first portion of the photo-curing resin can be pushed into the one end portion of the nozzle hole. Therefore, air bubbles can be prevented from being produced in the portion of the photo-curing resin that is located around the open end (i.e., ejection outlet) of the nozzle hole, and accordingly the cured second portion of the photo-curing resin can enjoy a stable or accurate shape. Thus, the ejection outlet of the nozzle hole can enjoy a stable or accurate shape and accordingly can eject droplets of liquid (e.g., ink) in an accurate direction. In addition, the nozzle plate can be prevented from being warped because of a difference of respective thermal contraction coefficients of the nozzle plate and the photo-curing-resin layer.

According to a second aspect of the present invention, there is provided a method of producing a nozzle plate. The method comprises preparing a nozzle plate having at least one nozzle hole which is formed through a thickness thereof, and an ejection surface in which one of opposite open ends of the at least one nozzle hole opens. A droplet of a liquid is ejected from the one open end of the at least one nozzle hole. The method further comprises treating the nozzle plate by the method according to the first aspect of the present invention.

According to a third aspect of the present invention, there is provided a method of producing an ink-jet recording head. The method comprises preparing a flow-channel unit which includes the nozzle plate treated by the method according to the first aspect of the present invention and has at least one flow channel including at least one pressure chamber which communicates with the at least one nozzle hole and supplies an ink to the at least one nozzle hole, preparing an actuator which changes a pressure of the ink in the at least one pressure chamber so as to eject a droplet of the ink from the at least one nozzle hole, and assembling the flow-channel unit and the actuator with each other so as to provide the ink-jet recording head.

### BRIEF DESCRIPTION OF THE DRAWINGS

The above and optional objects, features, and advantages of the present invention will be better understood by reading the following detailed description of the preferred embodiments of the invention when considered in conjunction with the accompanying drawings, in which:

FIG. 1 is a perspective view of an ink-jet recording head including a nozzle plate that is treated by a treating method to which the present invention is applied;

FIG. 2 is a cross-sectional view taken along lines 2-2 in FIG. 1;

FIG. 3 is a plan view of a main portion of the ink-jet recording head;

FIG. 4 is an enlarged plan view of a portion, A, of the main portion, indicated by one-dot chain line in FIG. 3;

FIG. 5 is a cross-sectional view taken along lines 5-5 in FIG. 4;

FIG. 6 is a plan view of a nozzle plate of the main portion;

FIG. 7 is an enlarged cross-sectional view of the nozzle plate;

FIG. 8A: is an enlarged cross-sectional view of a portion, B, of an actuator unit of the main portion, indicated by one-dot chain line in FIG. 5;

FIG. 8B is a plan view of an individual electrode of the actuator unit;

FIG. 9 is a flow chart representing a method of producing the ink-jet recording head;

FIGS. 10A, 10B, and 10C are views for explaining a method of producing the nozzle plate, FIG. 10A showing a metallic plate before nozzle holes are formed, FIG. 10B showing a recessed portion formed in the metallic plate, and FIG. 10C showing a nozzle hole obtained by working the recessed portion formed in the metallic plate;

FIG. 11 is an illustrative view showing a step of sandwiching, with a photo-curing-resin film and a carrier film, the nozzle plate;

FIGS. 12A and 12B are views showing steps of pushing respective portions of the photo-curing-resin film into the nozzle holes of the nozzle plate;

FIGS. 13A, 13B, 13C, and 13D are views showing steps of forming a water-repellent layer on the nozzle plate; and

FIG. 14 is a view corresponding to FIG. 12A and showing a state in which a laminated body is placed in a decompressing and pressing device, in a modified embodiment of the present invention.

### DETAILED DESCRIPTION OF THE PREFERRED EMBODIMENTS

Hereinafter, there will be described a preferred embodiment of the present invention by reference to the drawings.

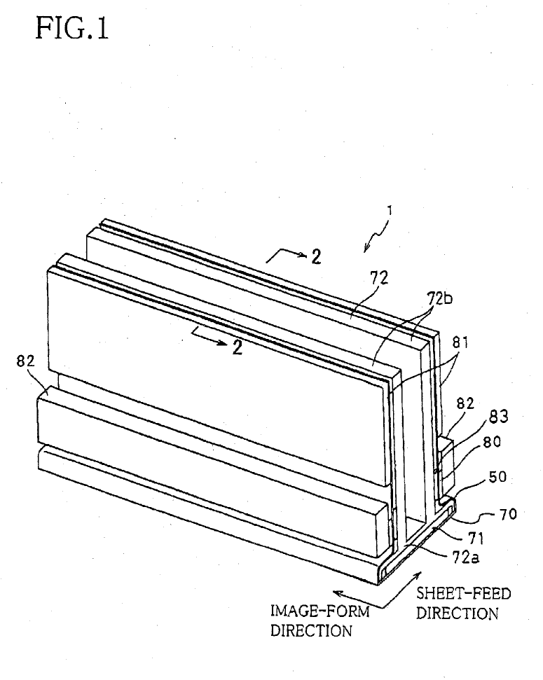

FIG. 1 shows an ink-jet recording head 1 including a nozzle plate 30 that has been treated by a treating method to which the present invention is applied. As shown in the figure, the recording head 1 includes a main portion 70 that ejects droplets of ink toward a recording sheet and has, in its plan view, a rectangular flat shape extending in an image-form direction; and a base block 71 that is located above the main portion 70 and has two ink reservoirs 3 that temporarily store the ink.

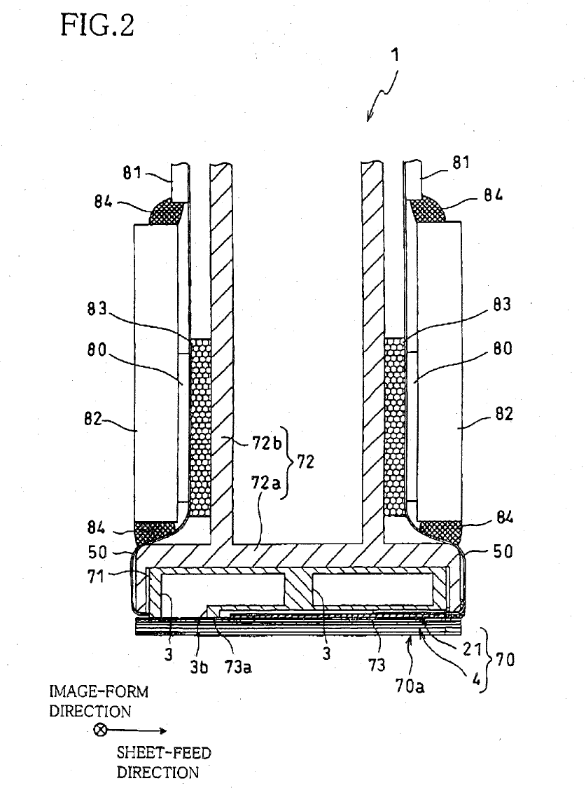

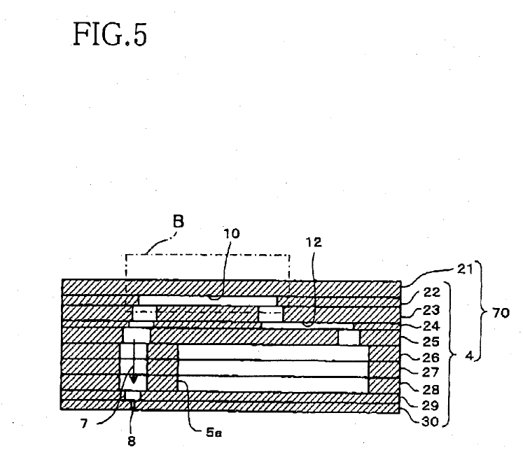

As shown in FIG. 2, the main portion 70 includes a flow-channel unit 4 having a plurality of individual ink-flow channels 7 (FIG. 5); and a plurality of (e.g., four) actuator units 21 each of which is adhered, with, e.g., a thermosetting epoxy adhesive, to an upper surface of the flow-channel unit 4. A plurality of (e.g., two) flexible printed circuits (FPC) 50 are bonded to respective upper surfaces of the actuator units 21, such that first, the two FPCs 50 are drawn leftward and rightward, respectively, and then the FPCs 50 are each drawn upward while being curved inward. However, four FPCs 50 may be bonded to the four actuator units 21, respectively.

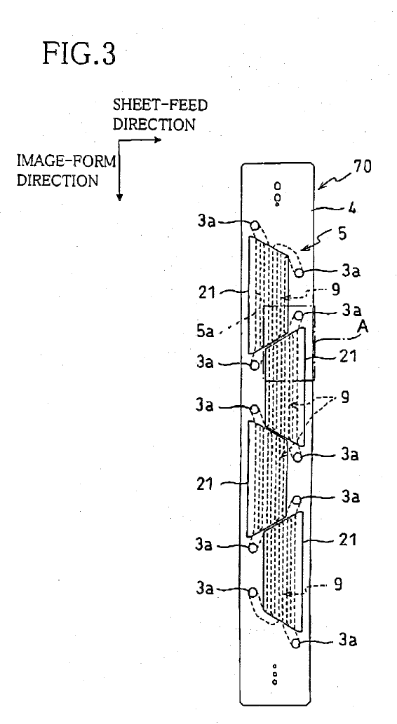

As shown in FIG. 3, the flow-channel unit 4 has a rectangular flat shape extending in the image-form direction. The flow-channel unit 4 has a plurality of manifold flow channels 5, indicated by broken lines, that are supplied with the ink via a plurality of inlet openings 3a from the ink reservoirs 3 of the base block 71. Each of the manifold flow channels 5 are branched into a plurality of sub-manifold flow channels 5a that extend parallel to a lengthwise direction of the flow-channel unit 4, i.e., the image-form direction.

Each of the four actuator units 21 has a generally trapezoidal shape in its plan view. The four actuator units 21 are adhered to the upper surface of the flow-channel unit 4, such that the actuator units 21 are arranged in two arrays in a zigzag or staggered fashion, and such that each of the actuator units 21 does not overlap any of the inlet openings 3a of the flow-channel unit 4. Each of the four actuator units 21 is disposed such that two parallel sides (i.e., an upper side and a lower side) of the each actuator unit 21 are parallel to the lengthwise direction of the flow-channel unit 4. The ten inlet openings 3a in total are arranged in two arrays in the lengthwise direction of the flow-channel unit 4, such that each of the two arrays includes the five inlet openings 3a, and such that each of the inlet openings 3a does not overlap any of the actuator units 21 adhered to the flow-channel unit 4. Like the actuator units 21, the inlet openings 3a are arranged in a staggered fashion. Respective inclined sides of each pair of actuator units 21 that are located adjacent each other in the lengthwise direction of the flow-channel unit 4, are partly opposed to each other in a sheet-feed direction perpendicular to the image-form direction.

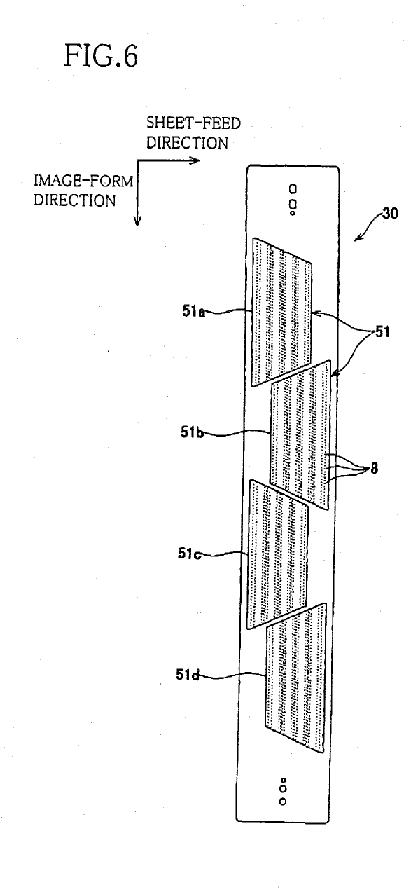

The main portion 70 has, as a lower surface thereon an ink ejection surface 70a having a plurality of nozzles (or nozzles holes) 8 each of which has a small diameter. The nozzles 8 are arranged like a matrix in each of a plurality of (e.g., four) areas corresponding to a plurality of adhesion areas to which the actuator units 21 are adhered. Thus, the ink ejection surface 70a has a plurality of (e.g., four) ink-ejection areas 51 (FIG. 6). In addition, the flow-channel unit 4 has, in the upper surface thereof to which the actuator units 21 are adhered, a plurality of (e.g., four) pressure-chamber areas 9 in each of which a plurality of pressure chambers 10 (FIG. 5) are arranged like a matrix. That is, each of the actuator units 21 has dimensions assuring that the each actuator unit 21 can cover the plurality of pressure chambers 10 of the corresponding pressure-chamber area 9. Thus, the actuator units 21, the pressure-chamber areas 9, and the ink-ejection areas 51 are similar to each other in shape.

Back to FIG. 2, the base block 71 is formed of a metallic material such as a stainless steel. The base block 71 has the inner, two ink reservoirs 3 each of which extends in a lengthwise direction of the base block 71 and has a generally rectangular-parallelepiped shape. Each of the ink reservoirs 3 has, in one end portion thereof an opening, not shown, through which the ink is supplied from an ink tank, not shown. Thus, the ink reservoirs 3 are full of the ink at any time. The two ink reservoirs 3 have ten outlet openings 3b in total through which the ink is supplied to the flow-channel unit 4. The ten outlet openings 3b are arranged in two arrays in a staggered fashion in the lengthwise direction of the base block 71, so that the ten outlet openings 3b can communicate with the ten inlet openings 3b of the flow-channel unit 4, respectively. That is, in a plan view, the ten outlet openings 3b of the two ink reservoirs 3 and the ten inlet openings 3a of the flow-channel unit 4 are aligned with each other, respectively.

A lower surface 73 of the base block 71 has ten thickened portions 73a each of which more or less projects downward from a remaining portion of the lower surface 73 and defines a corresponding one of the ten outlet openings 3b. The base block 71 contacts the upper surface of the flow-channel unit 4, at only the thickened portions 73a of the base block 71 that contact respective portions of the flow-channel unit 4 that define the inlet openings 3a thereof. Thus, the above-indicated remaining portion of the lower surface 73 of the base block 71 is kept away from the upper surface of the flow-channel unit 4, so as to define spaces, and the actuator units 21 and the FPCs 50 are provided in the thus defined spaces such that the actuator units 21 and the FPCs 50 are kept away from the lower surface 73 of the base block 71.

The ink-jet recording head 1 additionally includes a holder 72 having a holding portion 72a that holds the base block 71; and two projecting portions 72b that are distant from each other in the sheet-feed direction and each project upward from an upper surface of the holding portion 72a. The base block 71 is adhered and fixed to a recessed portion formed in a lower surface of the holding portion 72a of the holder 72. The FPCs 50, bonded to the actuator units 21, are first drawn out of the space left between the base block 71 and the main portion 70, and then drawn along respective outer surfaces of the projecting portions 72b while being kept away from the same 72b by respective elastic members 83 such as sponge rubbers. A plurality of driver ICs (integrated circuits) 80 are provided on respective portions of the FPCs 50 that are located along the respective outer surfaces of the projecting portions 72b. Each of the FPCs 50 sends drive signals outputted by a corresponding one of the driver ICs 80, to the corresponding actuator units 21 of the main portion 70. To this end, each FPC 50 is electrically connected, by soldering, to the corresponding driver IC 80 and the corresponding actuator units 21.

Two heat sinks 82 each of which has a generally rectangular-parallelepiped shape are held in close contact with respective outer surfaces of the driver ICs 80. Thus, the heat sinks 82 can efficiently radiate heat produced by the driver ICs 80. Two circuit substrates 81 are connected to respective outer sides of the FPCs 50, at respective positions above the driver ICs 80 and the heat sinks 82. Two sealing members 84 fill two spaces left between respective upper ends of the two heat sinks 82 and the two circuit substrates 81, and two spaces left between respective lower ends of the two heat sinks 82 and the two FPCs 50. Thus, the sealing members 84 prevent dust or ink from entering the main portion 70 of the ink-jet recording head 1. The sealing members 84 are not shown in FIG. 1.

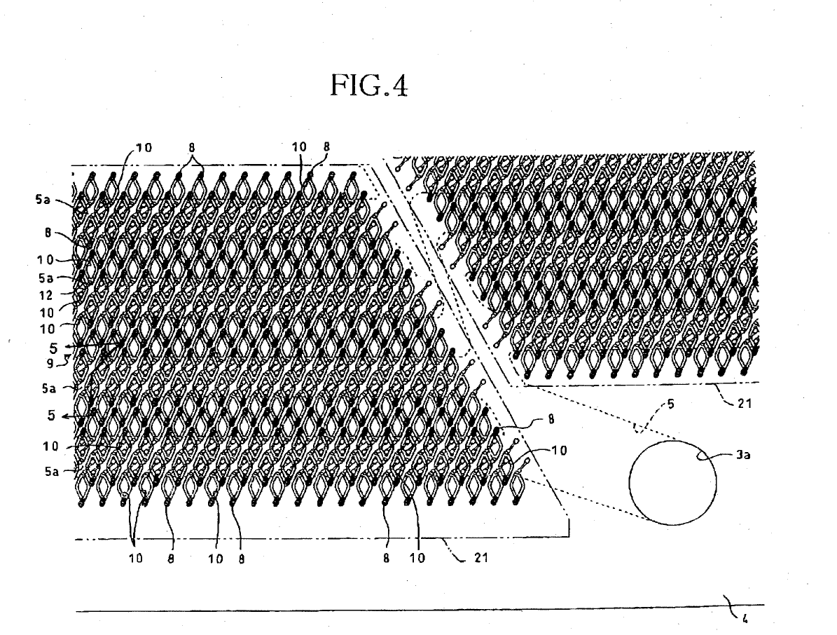

FIG. 4 is an enlarged view of an area, A, indicated by one-dot chain line in FIG. 3. As shown in FIG. 4, the flow-channel unit 4 has, in each of the four pressure-chamber areas 9 respectively opposed to the four actuator units 21, the four sub-manifold flow channels 5a extending parallel to each other in the lengthwise direction of the flow-channel unit 4, i.e., the image-form direction. The flow-channel unit 4 has, in the upper surface thereof, the plurality of pressure chambers 10 each of which has, in its plan view, a generally rhomboidal shape whose vertices are rounded. One of two acute-angle corners of each pressure chamber 10 communicates with a corresponding one of the nozzles 8, and the other acute-angle corner thereof communicates with a corresponding one of the sub-manifold flow channels 5a via an aperture 12. Thus, a plurality of individual ink-flow channels 7 (FIG. 5) that communicate with the nozzles 8, respectively, are connected to each of the sub-manifold Slow channels 5a. In FIG. 4, since the nozzles 8, the pressure chambers 10, and the apertures 12 are located under the actuator units 21, those elements 8, 10, 12 should be drawn at broken lines. In fact, however, those elements 8, 10, 12 are drawn at solid lines, for easier understanding purposes only.

Next, a cross-sectional structure of the main portion 70 will be described by reference to FIG. 5 showing the individual ink-flow channels 7. In the present embodiment, each individual ink-flow channel 7 extends upward from the corresponding sub-manifold flow channel 5a, and reaches the above-indicated other corner of the corresponding pressure chamber 10 formed in the upper surface of the flow-channel unit 4. Then, the each individual ink-flow channel 7 extends obliquely downward from the above-indicated one corner of the corresponding pressure chamber 1 extending in a horizontal direction, and reaches the corresponding nozzle 8 formed in the lower surface (i.e., the ink ejection surface 70a) of the flow-channel unit 4. Thus, each individual ink-flow channel 7 has a bow-like shape having the corresponding pressure chamber 10 at its top. Thus, the individual ink-flow channels 7 can be formed at a high density, and the ink can smoothly flow through each of the individual ink-flow channels 7.

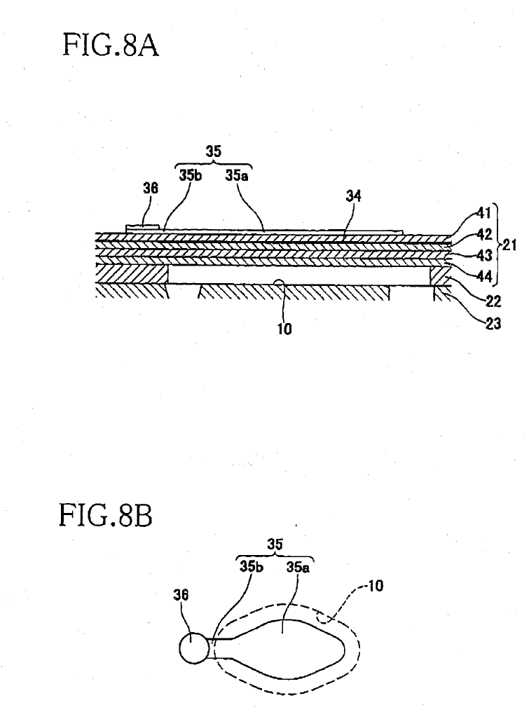

As shown in FIG. 5, the main portion 70 has a stacked structure wherein the actuator units 21 are stacked on the flow-channel unit 4. Each of the actuator units 21 and the flow-channel unit 4 has a stacked structure in which a plurality of thin sheets or plates are stacked on each other. As will be described later, each actuator unit 21 includes four piezoelectric sheets 41, 42, 43, 44 (FIG. 8A) stacked on each other, and additionally includes electrodes 34, 35. Only the uppermost one 41 of the four piezoelectric sheets can function as a plurality of active portions corresponding to the plurality of pressure chambers 10, respectively, when an electric field is applied to the each actuator unit 21 (hereinafter, the uppermost piezoelectric sheet 41 will be referred to as the active piezoelectric sheet 41, where appropriate). The other three piezoelectric sheets 42, 43, 44 are non-active piezoelectric sheets.

The flow-channel unit 4 has a stacked structure wherein nine plate members are stacked on each other. Those nine plates include a cavity plate 22, a base plate 23, an aperture plate 24, a supply plate 25, three manifold plates 26, 27, 28, a cover plate 29, and a nozzle plate 30.

The cavity plate 22 is a metallic plate having, in each of the adhesion areas of the flow-channel unit 4 to which the actuator units 21 are adhered, a plurality of generally rhomboidal holes defining the pressure chambers 10, respectively. The base plate 23 is a metallic plate having, for each of the pressure chambers 10 of the cavity plate 22, a first communication hole to communicate the each chamber 10 with the corresponding aperture 12, and a second communication hole to communicate the each chamber 10 with the corresponding nozzle 8.

The aperture plate 24 is a metallic plate having, for each of the pressure chambers 10, an aperture hole defining the corresponding aperture 12, and a communication hole to communicate the each chamber 10 with the corresponding nozzle 8. The supply plate 25 is a metallic plate having, for each of the pressure chambers 10, a first communication hole to communicate the corresponding aperture 12 with the corresponding sub-manifold flow channel 5a, and a second communication hole to communicate the each chamber 10 with the corresponding nozzle 8. The three manifold plates 26, 27, 28 are metallic plates that cooperate with each other to define, for each of the pressure chambers 10, the corresponding sub-manifold flow channel 5a, and respective communication holes to communicate the each chamber 10 with the corresponding nozzle 8. The cover plate 29 is a metallic plate having, for each of the pressure chambers 10, a communication hole to communicate the each chamber 10 with the corresponding nozzle 8. The nozzle plate 30 is a metallic plate having, for each of the pressure chambers 10, a communication hole to communicate the each chamber 10 with the corresponding nozzle 8.

As shown in FIG. 5, the nine plates 22 through 30 are stacked on each other, in a state in which those plates are accurately positioned relative to each other so as to form the individual ink-flow channels 7. In the present embodiment, the nine plates 22 through 30 are formed of a same metallic material, i.e., Stainless Steel SUS430. However, in place of Stainless Steel SUS430, other metallic materials such as Stainless Steel SUS316 or Alloy 42 may be used. Otherwise, the nine plates 22 through 30 may be formed of different metallic materials.

As shown in FIG. 5, each pressure chamber 10 and the corresponding aperture 12 are formed in the different plate members 22, 24, i.e., at different levels in the direction of stacking of the nine plate members 22 through 30. Therefore, as shown in FIG. 4, each aperture 12 communicating with the corresponding pressure chamber 10 can be formed, in the plan view of the flow-channel unit 4 opposed to the actuator units 21, at a position where the each aperture 12 overlaps another pressure chamber 10. Thus, the pressure chambers 10 can be formed at an increased density and accordingly the ink-jet recording head 1 occupies a considerably small space and accordingly can record an image at an increased degree of resolution.

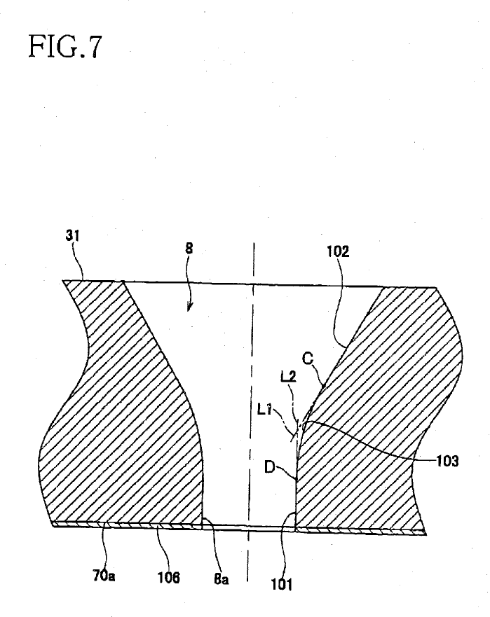

Hereinafter, the nozzle plate 30 will be described by reference to FIGS. 6 and 7. As shown in FIG. 6, the nozzle plate 30 has a plurality of ink-ejection areas 51 (51a, 51b, 5ic, 51d) in each of which the nozzles 8 are provided adjacent each other like a matrix and which correspond to the plurality of actuator units 21, respectively, that are adhered to the upper surface of the flow-channel unit 4. In the present embodiment, the four ink-ejection areas 51a, 51b, 51c, 51d are arranged in two arrays in a zigzag or staggered fashion in a lengthwise direction of the nozzle plate 30. Each of the ink-ejection areas 51a, 51b, 51c, 51d has a generally trapezoidal shape in its plan view, and is disposed such that respective inclined sides of each pair of ink-ejection areas 51 that are located adjacent each other in the lengthwise direction of the nozzle plate 30 are partly opposed to each other in a widthwise direction of the nozzle plate 30. Thus, the four ink-ejection areas 51 are aligned with the four actuator units 21, respectively, and the four pressure-chamber areas 9, respectively.

As shown in FIG. 7, the nozzle plate 30 has the plurality of nozzles (or nozzles holes) 8 each of which is formed through a thickness of the nozzle plate 30. An open end of each nozzle 8 (i.e., a lower end of each nozzle 8 in FIG. 7) has a diameter of 20 μm and functions as an ejection outlet 8a. Each nozzle 8 includes a straight portion 101 having a cylindrical inner surface; a tapered portion 102 having a truncated-conical inner surface; and a curved portion 103 connecting between the straight portion 101 and the tapered portion 102. An upper end of the tapered portion 102 that opens in the upper surface 31 of the nozzle plate 30 has the largest diameter, and a lower end of the tapered portion 102 that is connected to the curved portion 103 has the smallest diameter.

The curved portion 103 is, in a cross section taken along a plane containing a centerline of each nozzle 8, defined by two circular arcs each of which has, at an upper end, C, where the curved portion 103 is connected to the tapered portion 102, i.e., at the smallest-diameter end of the tapered portion 102, a tangential line, L1, parallel to a straight line defining the tapered portion 102; and additionally has, at a second end, D, where the curved portion 103 is connected to the straight portion 101, i.e., at an upper end of the straight portion 101, a tangential line, L2, parallel to a straight line defining the straight portion 101. Since the tangential line L1 at the first end C of the curved portion 103 is parallel to the straight line defining the tapered portion 102, the first end C is not an inflection point and accordingly the inner diameter of the curved portion 103 smoothly changes at the first end C; and since the tangential line L2 at the second end D of the curved portion 103 is parallel to the straight line defining the straight portion 101, the second end D is not an inflection point and accordingly the inner diameter of the curved portion 103 smoothly changes at the second end D.

On the ink-ejection surface (i.e., the lower surface) 70a of the nozzle plate 30, a water-repellent layer or film 106 having a substantially constant thickness is formed as, e.g., a nickel plating containing a fluoric high polymer material such as polytetrafluoroethylene. Since the water-repellent film 106 is formed around the ejection outlet 8a of each nozzle 8, ink or dust is effectively prevented from sticking to the periphery of the ejection outlet 8a, and accordingly a direction in which the ink is ejected from each nozzle 8 is effectively prevented from being changed or deflected.

Next, each of the actuator units 21 will be described by reference to FIGS. 8A and 8B. FIG. 8A is an enlarged cross-section view of a portion, B, of each actuator unit 21, indicated by one-dot chain line in FIG. 5; and FIG. 8B is a plan view of each of the individual electrodes 35. As shown in those figures, each individual electrode 35 is opposed to the corresponding pressure chamber 10, and includes a main portion 35a that is formed in an area fully aligned with the corresponding pressure chamber 10, and an auxiliary portion 35b that is electrically connected to the main portion 35a but is: not aligned with the corresponding pressure chamber 10.

As shown FIG. 8A, each actuator unit 21 includes four piezoelectric sheets 41, 42, 43, 44 each of which has a thickness of about 15 dime Each of the four piezoelectric sheets 41, 42, 43, 44 is a continuous planar layer that is opposed to the four pressure-chamber areas 9 of the flow-channel unit 4. Since each piezoelectric sheet 41, 42, 43, 44 is constituted by a continuous planar layer opposed to the four pressure-chamber areas 9, the individual electrodes 35 can be formed at a high density on the piezoelectric sheet 41 by using, e.g., a screen-printing method. Therefore, the pressure chambers 10 that should be so formed as to be opposed to the individual electrodes 35 can be formed at a high density. Thus, recording of images can be performed at a high degree of resolution. Each of the piezoelectric sheets 41, 42, 43, 44 is formed of a ferroelectric ceramic material such as lead zirconate titanate (PZT).

As shown in FIG. 8B, the main portion 35a of each individual electrode 35 formed on the uppermost piezoelectric sheet 41 has a substantially rhomboidal, flat shape similar to each pressure chamber 10. More specifically described, each of four corners of the rhomboidal main portion 35a is defined by a smooth curve, e.g., a circular arc. One of two acute-angle corners of the rhomboidal main portion 35a is extended and is connected to the auxiliary portion 35b. On one end portion of the auxiliary portion 35b, a circular land 36 is formed such that the land 36 is electrically connected to the each individual electrode 35. As shown in FIG. 8B, the land 36 is opposed to a portion of the cavity plate 22 that is free of the pressure chambers 10. The land 36 is formed of e.g., gold containing glass frit, on an upper surface of the auxiliary portion 35b of the each individual electrode 35.

The common electrode 34 that has the same contour as that of the uppermost piezoelectric sheet 41 and has a thickness of about 2 μm, is provided between the uppermost piezoelectric sheet 41 and the underlying piezoelectric sheet 42. Each of the individual electrodes 35 and the common electrode 34 is formed of a metallic material such as a silver-palladium (Ag-Pd) alloy.

The common electrode 34 is grounded at a portion thereon not shown. Thus, the common electrode 34 has, at respective portions thereof opposed to the pressure chambers 10, a certain electric potential, i.e., a ground potential.

Next, a manner in which each actuator unit 21 is driven or operated will be described. Only the uppermost piezoelectric sheet 41 of each actuator unit 21 is polarized, in advance, in a direction of thickness thereof. Thus, each actuator unit 21 has a “uni-morph” structure in which the uppermost piezoelectric sheet 41 distant from the pressure chambers 10 includes the active portions and the other, three piezoelectric sheets 42, 43, 44 near to the pressure chambers 10 do not have any active portions. Therefore, when a certain positive or negative electric voltage is applied to an arbitrary one of the individual electrodes 35, such that an electric field is produced in the same direction as the direction of polarization of a corresponding active portion of the uppermost piezoelectric sheet 41 that is sandwiched by the arbitrary individual electrode 35 and the common electrode 34, the corresponding active portion contracts, owing to transverse piezoelectric effect, in a direction perpendicular to the direction of polarization thereof, and thereby functions as a pressure applying portion.

Thus, in the present embodiment, each of the active portions of the uppermost piezoelectric sheet 41 each of which is sandwiched by a corresponding one of the individual electrodes 35 and the common electrode 34 produces, owing to the piezoelectric effect, a strain upon application thereto of an electric field. On the other hand, no electric voltage is externally applied to the three piezoelectric sheets 42 through 44 located under the uppermost piezoelectric sheet 41, and accordingly those piezoelectric sheets 42 through 44 cannot function as an active portion. Therefore, each of respective portions of the uppermost piezoelectric sheet 41 that are sandwiched by the respective main portions 35a of the individual electrodes 35 and the common electrode 34 can contract, owing to the transverse piezoelectric effect, in the direction perpendicular to the direction of polarization thereof.

On the other hand, none of the other piezoelectric sheets 42, 43, 44 displaces because those sheets 42 through 44 are not influenced by the electric field. Thus, a strain difference is produced between the strain produced by the uppermost piezoelectric sheet 41 and that produced by the other piezoelectric sheets 42 through 44, with respect to the direction perpendicular to the direction of polarization thereof so that the other piezoelectric sheets 42 through 44 are so deformed as to swell in a direction away from the active portions of the uppermost piezoelectric sheet 41. This is a “uni-morph” deformation. Since, as shown in FIG. 8A, the lower surface of each actuator unit 21 including the four piezoelectric sheets 41 through 44 is fixed to respective upper surfaces of a plurality of partition walls of the cavity plate 22 that define the pressure chambers 10, the other piezoelectric sheets 42 through 44 are so deformed as to swell into the corresponding pressure chamber 10. Thus, a volume of the pressure chamber 10 is decreased and a pressure of the ink present in the pressure chamber 10 is increased, so that a droplet of the ink is ejected from the corresponding nozzle 8. Subsequently, when the electric potential of the corresponding individual electrode 35 is returned to the same level as that of the common electrode 34, the four piezoelectric sheets 41 through 44 are returned to their original shapes, so that the volume of the pressure chamber 10 is returned to its original volume and a certain amount of the ink is sucked from the corresponding manifold flow channel 5 into the pressure chamber 10.

However, each actuator unit 21 may be driven in a different manner in which an arbitrary one of the individual electrodes 35 is changed to an electric potential different from that of the common electrode 34 and, each time an ink-ejection request is received, the arbitrary individual electrode 35 is returned to the same electric potential as that of the common electrode 34 and then is changed, at an appropriate timing, to the electric potential different from that of the common electrode 34. In this method, at the timing when the respective electric potentials of the arbitrary individual electrode 35 and the common electrode 34 become equal to each other, the four piezoelectric sheets 41 through 44 are returned to their original shapes, so that the volume of the corresponding pressure chamber 10 is increased as compared with the volume thereof in its initial state in which the respective electric potentials of the arbitrary individual electrode 35 and the common electrode 34 differ from each other. Consequently a certain amount of the ink is sucked from the corresponding manifold flow channel 5 into the pressure chamber 10. Then, at the timing when the arbitrary individual electrode 35 is changed to the electric potential different from that of the common electrode 34, the piezoelectric sheets 41 through 44 are so deformed as to swell into the pressure chamber 10, so that the volume of the pressure chamber 10 is decreased, the pressure of the ink is increased, and a droplet of the ink is ejected from the corresponding nozzle 8. Consequently a desired image is printed on a recording sheet while the ink-jet recording head 1 is moved in the image-form direction.

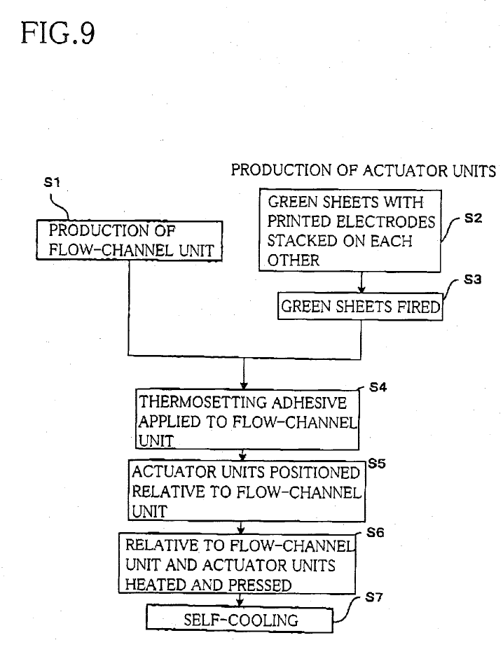

Hereinafter, there will be described a method of producing the ink-jet recording head 1, by reference to a flow chart shown in FIG. 9.

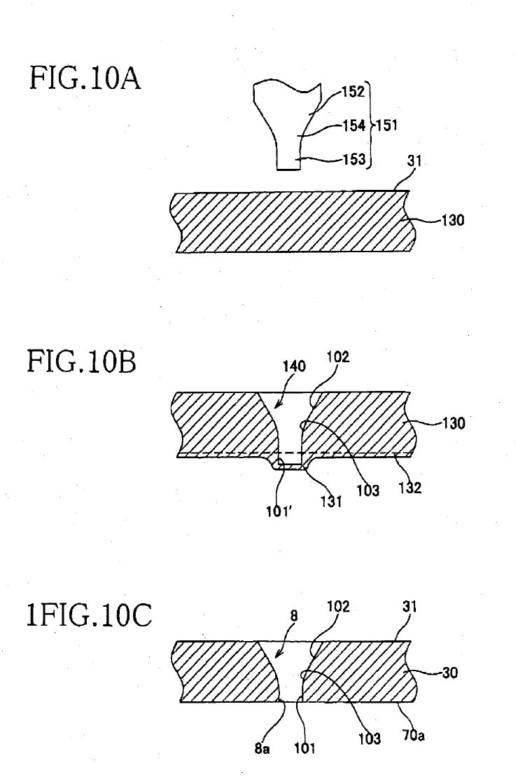

The ink-jet recording head 1 is produced by producing sub-assemblies, i.e., the flow-channel unit 4 and the actuator units 21, and then assembling those sub-assemblies into the head 1. First, at Step S1, the flow-channel unit 4 is produced. To this end, each of the eight plate members 22 through 29, except for the nozzle plate 30, is subjected to etching using a photo-resist mask having an appropriate pattern, so that the each plate member 22 through 29 has the appropriate holes as shown in FIG. 5. Then, as will be described later, a punch 151 (FIG. 10A) is used to form the nozzle holes 8 in a metallic plate 130 as a base material of the nozzle plate 30, and the water-repellent layer 106 is formed on the lower surface (i.e., ink ejection surface) 70a of the metallic plate 130. Subsequently, the nine plate members 22 through 30 are positioned relative to each other so as to define the individual ink-flow channels 7, and are adhered, with the thermosetting epoxy adhesive, to each other. Then, the nine plate members 22 through 30 are pressed while being heated up to a temperature not lower than a temperature at which the epoxy adhesive is set. Thus, the epoxy adhesive is set and the nine plate members 22 through 30 are fixed to each other, and the flow-channel unit 4, shown in FIG. 5, is obtained. Since the nine plate members 22 through 30 are formed of the same metallic material those plate members 22 through 30 have a same linear expansion coefficient and accordingly the flow-channel unit 4 is not warped.

At Steps S2 and S3, each actuator unit 21 is produced. First, at Step S2, a plurality of green sheets each formed of a piezoelectric ceramic material are prepared. Those green sheets are formed while shrinking thereof caused by firing is taken into account. On one of those green sheets, an electrically conductive paste is applied, by screen printing, to form a pattern corresponding to the common electrode 34. While all those green sheets are positioned relative to each other by using a jig, another green sheet having no conductive-paste pattern is stacked on the one green sheet having the pattern corresponding to the common electrode 34, and the thus obtained green sheets are stacked on two more green sheets which are stacked on each other and each of which has no conductive-paste pattern, so as to obtain a stacked body.

Then, at Step S3, the thus obtained stacked body is degreased in a manner known in the art of ceramics, and then is fired at an appropriate temperature. Thus, the four green sheets are formed into the four piezoelectric sheets 41 through 44, respectively, and the conductive-paste pattern is formed into the common electrode 34. Subsequently, on the uppermost piezoelectric sheet 41, an electrically conductive paste is applied, by screen printing, to form a pattern corresponding to the plurality of individual electrodes 35. This stacked body is fired to convert the conductive-paste pattern formed on the piezoelectric sheet 41, into the individual electrodes 35. Then, gold containing glass frit is printed on the individual electrodes 35 so as to form the lands 36. Thus, the actuator unit 21, shown in FIGS. 8A and 8B, is produced.

Step S1 to produce the flow-channel unit 4, and Steps S2 and S3 to produce each actuator unit 21 are carried out independent of each other Therefore, Step S1 may be carried out before or after, or concurrently with, Steps S2 and S3.

Next, at Step S4, a thermosetting epoxy adhesive which is set at about 80° C. is applied, with a bar coater, to an outer surface of the flow-channel unit 4 (obtained at Step S1) that has a plurality of holes or recesses corresponding to the pressure chambers 10. This thermosetting epoxy adhesive is of a two-liquid mixture type.

Subsequently, at Step S5, the four actuator units 21, each obtained at Steps S2 and S3, are placed on the epoxy-adhesive layer formed on the flow-channel unit 4, while each of the actuator units 21 is positioned relative to the flow-channel unit 4 such that the active portions of the each actuator unit 21 are opposed to the pressure chambers 10 of a corresponding one of the pressure-chamber areas 9. The positioning of each actuator unit 21 relative to the flow-channel unit 4 is carried out by using positioning marks, not shown, that are formed on the flow-channel unit 4 and the each actuator unit 21 at Steps S1 through S3.

Then, at Step S6, the stacked body including the flow-channel unit 4, the four actuator units 21, and the epoxy-adhesive layer provided between the flow-channel unit 4 and the actuator units 21, is placed in a heating and pressing device, not shown, and is pressed while being heated up to a temperature not lower than a temperature at which the epoxy adhesive is thermally set. Next, at Step S7, the stacked body is taken out of the heating and pressing device, and the temperature of the body is lowered by self-cooling. Thus, the main portion 70 including the flow-channel unit 4 and the four actuator units 21 is obtained.

Then, the two FPCs 50 are adhered to the four actuator units 21, and the base block 71 is adhered to the main portion 70. Thus, the ink-jet recording head 1 is produced.

Hereinafter, there will be described a method of treating and producing the nozzle plate 30 as a portion of the flow-channel unit 4, by reference to FIGS. 10A, 10B, and 10C. FIG. 10A shows the metallic plate 130 and the punch 151 before the nozzle holes 8 are formed in the metallic plate 130 by using the punch 151; FIG. 10B shows one of a plurality of recessed portions 140 formed in the metallic plate 130 by using the punch 151, before those recessed portions 140 are worked into the nozzle holes 8; and FIG. 10C shows ore of the nozzle holes 8 formed in the metallic plate 130 by working the recessed portions 140.

The nozzle plate 30 is produced as follows: First, as shown in FIG. 10A, the punch 151 as a portion of dies is driven into the upper surface 31 of the metallic plate 130 that is formed of Stainless Steel SUS430 and has a rectangular flat shape. The punch 151 includes a tapered portion 152 that has a truncated-conical shape and is located on the side of a base end thereof a cylindrical portion 153 that is located on the side of a free end thereof, and a curved portion 154 that connects between the tapered portion 152 and the cylindrical portion 153.

The punch 151 is driven by a stroke assuring that the punch 151 does not penetrate the thickness of the metallic plate 130, so that a recessed portion 140 is formed in the metallic plate 130, as shown in FIG. 10B. Thus, the recessed portion 140 includes the tapered portion 102 corresponding to the tapered portion 152 of the punch 151; a bottomed straight portion 101′ corresponding to the cylindrical portion 153 of the same 151; and the curved portion 103 corresponding to the curved portion 154 of the same 151.

As shown in FIG. 10B, since the punch 151 is driven into the metallic plate 130, a raised portion 131 is naturally formed on the lower surface of the same 130. Therefore, as shown in FIG. 10C, the raised portion 131 is removed from the lower surface of the metallic plate 130, by machining (e.g., grinding) the lower surface and thereby flattening the same. Thus, the respective ejection outlets 8a of the nozzle holes 8 are formed in the lower surface of the metallic plate 130. Simultaneously, a lower portion 132 of the metallic plate 130, indicated by broken line in FIG. 10B, is removed from a remaining portion of the same 130. Thus, the nozzle plate 30 in which each nozzle hole 8 includes the straight portion 101 is produced as shown in FIG. 10C.

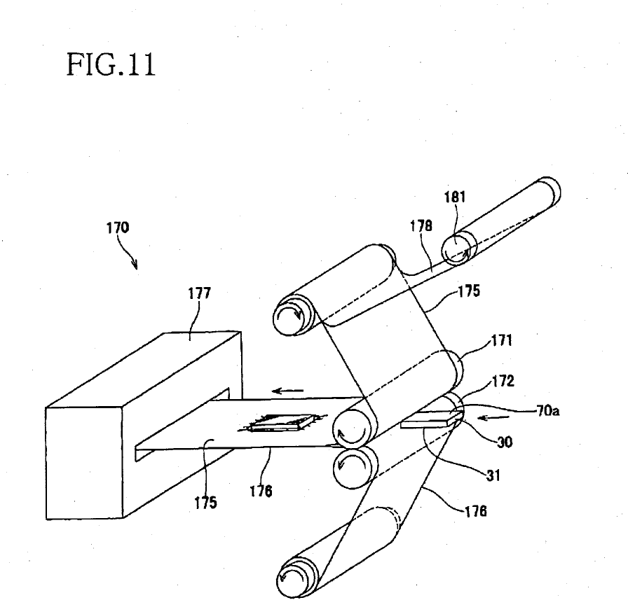

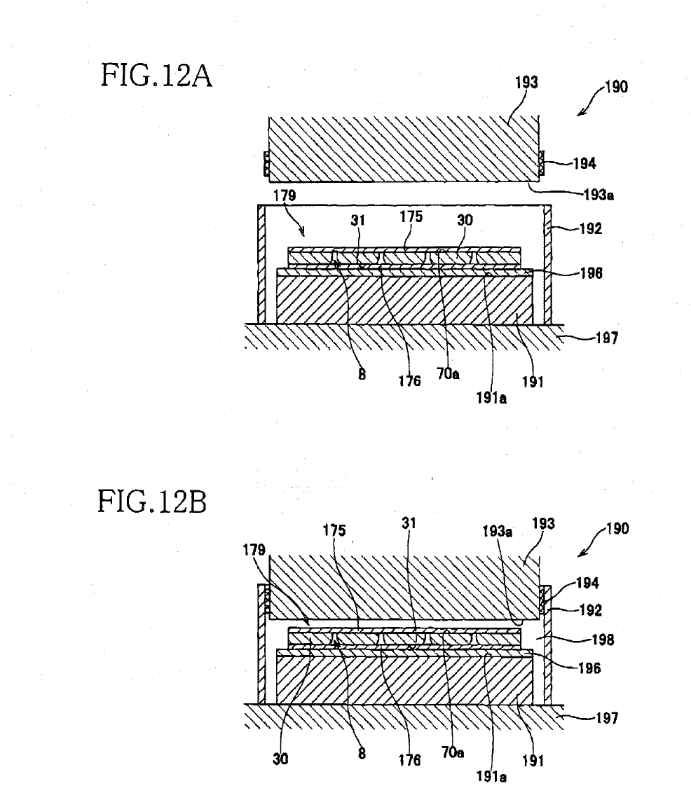

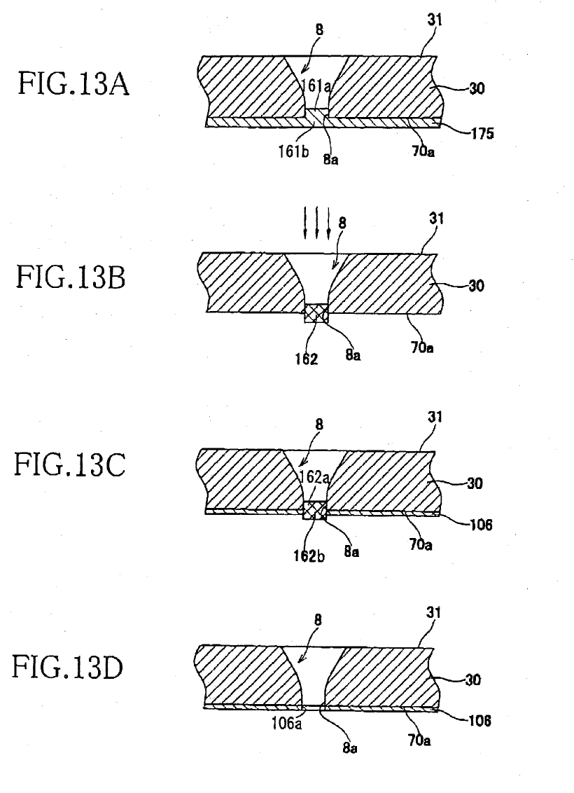

Next, there will be described a method of treating the nozzle plate 30, by reference to FIGS. 11, 12A, 12B, and 13A, 13B, 13C, 13D. FIG. 11 shows a step of sandwiching, with a photo-curing-resin layer or sheet 175 and a carrier sheet 176, the nozzle plate 30; FIGS. 12A and 12B show steps of pushing a portion of the photo-curing resin of the sheet 175, into filling one end portion of each of the nozzle holes 8; and FIGS. 13A, 13B, 13C, and 13D show steps of forming the water-repellent layer 106.

The nozzle plate 30 is treated to form the water-repellent layer 106. However, the respective ejection outlets 8a of the nozzle holes 8 and the respective end portions of the nozzle holes 8 that are continuous with the ejection outlets 8a should not be coated with the water-repellent layer 106, because the ink-ejecting characteristic of the nozzle plate 30 is adversely influenced if the water-repellent layer 106 is formed in the ejection outlets 8a and the respective end portions adjacent to the same 8a. The remaining portion of the lower surface of the nozzle plate 30 should be coated with the water-repellent layer 106 in an appropriate manner. To this end, the photo-curing-resin sheet 175 and the nozzle plate 30 are integrated with each other. In the present embodiment, a laminating device 170, shown in FIG. 11, is used to laminate the belt-like photo-curing-resin sheet 175 on the nozzle plate 30 so as to provide a laminated body. More specifically described, the photo-curing-resin sheet 175 is laminated on the lower surface 70a of the nozzle plate 30 that has the ink-ejection areas 51, and the carrier sheet 176 is laminated on the upper surface 31 of the same 30, located on the underside of the same 30 as seen in FIG. 11. This is a laminating step. The laminating device 170 includes a pair of nip rollers 171, 172 that are opposed to each other; and a take-up portion 177 that takes up the laminated body including the nozzle plate 30, and the photo-curing-resin sheet 175 and the carrier sheet 176 each of which is laminated on the nozzle plate 30. The two nip rollers 171, 172 are located near to each other such that the two nip rollers 171, 172 cooperate with each other to nip and press the photo-curing-resin sheet 175 and the carrier sheet 176 each against the nozzle plate 30. The laminating device 170 additionally includes a take-up roller 181 that takes up a cover (or support) sheet 178, adhered to the photo-curing-resin sheet 175, while peeling the former sheet 178 from the latter sheet 175.

The two nip rollers 171, 172 cooperate with each other to nip the nozzle plate 30 in such a manner that a widthwise direction of the nozzle plate 30 is parallel to respective axial directions of the nip rollers 171, 172, i.e., parallel to respective axis lines about which the nip rollers 171, 172 are rotated- While the nip rollers 171, 172 are rotated, the take-up portion 177 takes up the laminated body including the nozzle plate. 30, the photo-curing-resin sheet 175, and the carrier sheet 176. Thus, the adhesive surface of the photo-curing-resin sheet 175 is held in adhered contact with the lower surface 70a of the nozzle plate 30, so as to close the respective ejection outlets 8a of the nozzle holes 8; and simultaneously, the carrier sheet 176 is held in close contact with the upper surface 31 of the nozzle plate 30, so as to close the respective opposite open ends of the nozzle holes 8. Since the two nip rollers 171, 172 continue pressing the photo-curing-resin sheet 175 and the carrier sheet 176 against the nozzle plate 30; respectively, little by little, from one of lengthwise opposite end portions thereof toward the other end portion thereof, air is efficiently expelled from between each of the two sheets 175, 176 and the nozzle plate 30. In addition, the two sheets 175, 176 are held in close contact with the nozzle plate 30, without producing wrinkles. Moreover, in the present embodiment, a nip length that is defined, in the axial directions of the nip rollers 171, 172, as a length of a portion of the nozzle plate 30 that is nipped by the nip rollers 171, 172 is the smallest, because the nip length is equal to a dimension of the nozzle plate 30 in the widthwise direction thereof perpendicular to the lengthwise direction thereof. Therefore, even if respective widthwise opposite ends of the nozzle plate 30 may be pressed with different pressing forces by the two nip rollers 171, 172, a difference of the two pressing forces is very small and accordingly is negligible. Thus, air can be effectively prevented from being involved into between each of the two sheets 175, 176 and the nozzle plate 30. Furthermore, since the nozzle holes 8 are closed by the two sheets 175, 176, dust can be effectively prevented from entering the nozzle holes 8.

The carrier sheet 176 is formed of polyethylene terephthalate as a sort of resin, and does not have adhesiveness. However, since the carrier sheet 176 is adhered to a portion of the photo-curing-resin sheet 175 that surrounds the nozzle plate 30, the carrier sheet 176 is held in close contact with the nozzle plate 30. In addition, since the carrier sheet 176 is very thin, substantially no air is left between the carrier sheet 176 and the nozzle plate 30 and accordingly the carrier sheet 176 is held in close contact with the nozzle plate 30.

Subsequently, the photo-curing-resin sheet 175 and the carrier sheet 176, each held in contact with the nozzle plate 30, are cut along the contour of the nozzle plate 30, so that four side surfaces of the nozzle plate 30 are exposed. Thus, a laminated body 179 is obtained which includes the nozzle plate 30, and the photo-curing-resin sheet 175 and the carrier sheet 176 each of which has substantially the same contour as that of the nozzle plate 30 and is laminated on the same 30. The thus obtained laminated body 179 is placed in a decompressing and pressing device 190, as shown in FIG. 12A. The decompressing and pressing device 190 includes a flat stage 191 incorporating a heater, not shown; a cylindrical wall 192 surrounding the stage 191; a base 197 to which the stage 191 and the wall 192 are fixed; and a flat pusher 193 incorporating another heater, not shown. An annular sealing member 194 is fixed to an outer circumferential surface of the pusher 193 and, as shown in FIG. 12B, the sealing member 194 seals the pusher 193 to the wall 192 when the pusher 193 is moved downward. A lower surface 193a of the pusher 193 is parallel to an upper surface 191a of the stage 191. A flexible sheet 196 that is formed of a resin or a rubber is provided on the upper surface 191a of the stage 191, and accordingly the laminated body 179 is placed on the flexible sheet 196, such that the carrier sheet 176 is contacted with the flexible sheet 196.

As shown in FIG. 12B, the pusher 193 is moved downward to a position where the sealing member 194 is brought into contact with the wall 192 but the lower surface 193a of the pusher 193 is not contacted with the laminated body 179. Thus, an air-tight space 198 is produced which is defined by the wall 192, the pusher 193, and the base 197. Then, a degree of vacuum of the air-tight space 198 is increased up (i.e., an air pressure in the air-tight space 198 is decreased down) to about 1,000 Pa by a decompressing device, not shown. The air pressure in the air-tight space 198 may be lowered to not higher than 1,500 Pa, or not higher than 1,200 Pa, depending upon sorts of photo-curing resins used. Since the photo-curing-resin sheet 175 is adhered to the nozzle plate 30 but the carrier sheet 176 is just contacted with the same 30, not only air remaining in the nozzle holes 8 but also air possibly remaining between the photo-curing-resin sheet 175 and the nozzle plate 30 are expelled via between the nozzle plate 30 and the photo-curing-resin sheet 175.

In the present embodiment, the photo-curing-resin sheet 175 is formed of an acrylic photo-curing resin such as “Ordyl FP-215” available from Tokyo Ohka Kogyo Co., LTD., Japan. A glass-transition temperature of the photo-curing-resin sheet 175 under an atmospheric pressure is about 70° C. However, since the air pressure in the air-tight space 198 is lowered, the glass-transition temperature of the photo-curing-resin sheet 175 is also lowered to about 30° C. While the air pressure in the air-tight space 198 is kept at the lowered pressure, the pusher 193 is moved downward to press the photo-curing-resin sheet 175 against the nozzle plate 30, and a portion of the photo-curing resin of the sheet 175 is pushed into one end portion of each nozzle hole 8. As an example, the photo-curing-resin sheet 175 is pressed against the nozzle plate 30, with a pressing pressure of from 2.8×105 Pa to 8.3×105 Pa and for a time duration of from 2 minutes to 3 minutes, or with a pressing pressure of from 4.2×106 Pa to 6.9×106 Pa and for a time duration of from 10 seconds to 1 minute. The photo-curing-resin sheet 175 may be pressed against the nozzle plate 30, with a pressing pressure of 6.3×105 Pa and for a time duration of about 2 minutes. This is a pushing step. Even if a temperature of the air-tight space 198 may be a room temperature, i.e., fall in a temperature range of from 20° C. to 30° C., the photo-curing-resin sheet 175 is in a more or less softened state because of the lowered air pressure, and accordingly respective portions of the photo-curing-resin sheet 1175 can be easily pushed into the respective end portions of the nozzle holes 8. Therefore, at the room temperature, the laminated body 179 need not be heated by the respective heaters of the stage 191 and the pusher 193. However, if the temperature in the air-tight space 198 is lower than 20° C., then the laminated body 179 is heated up to the temperature of from 20° C. to 30° C., by the respective heaters of the stage 191 and the pusher 193, and the pusher 193 is moved to press the photo-curing-resin sheet 175 against the nozzle plate 30 and thereby push the respective portions of the photo-curing resin of the sheet 175 into the respective end portions of the nozzle holes 8. That is, even if the glass-transition temperature of the photo-curing resin may be lowered by lowering the air pressure in the air-tight space 198, the respective end portions of the nozzle holes 8 cannot be filled with respective sufficient amounts of the photo-curing resin, when the temperature in the air-tight space 198 is too low. Therefore, the laminated body 179 is heated up to the temperature of from 20° C. to 30° C., so as to soften the photo-curing-resin sheet 175. However, if the temperature in the air-tight space 198 is higher than 30° C. under the condition that the air pressure in the air-tight space 198 is kept at the lowered pressure, the photo-curing-resin sheet 175 becomes too soft, i.e., the amount of the photo-curing resin that is pushed into each nozzle hole 8 varies too largely as the pressing force of the pusher 193 changes. Therefore, the efficiency of the operation of pushing the photo-curing resin into the nozzle holes 8 lowers. In contrast, in the present embodiment, the amount of the photo-curing resin pushed into each nozzle hole 8 can be accurately controlled to a desirable value by selecting an appropriate pushing force of the pusher 193. In the present embodiment, a thickness of the photo-curing-resin sheet 175 is selected at a value not greater than the inner diameter of the straight portion 101 of each nozzle hole 8, so as to help push an appropriate amount of the photo-curing resin into the end portion of each nozzle hole 8 and thereby form a columnar cured portion 162, described later, in the end portion of each nozzle hole 8.

Since the upper surface 191a of the stage 191 and the lower surface 193a of the pusher 193 are parallel to each other, a substantially same amount of the photo-curing resin of the sheet 175 can be pushed into each of the nozzle holes 8. In addition, since the laminated body 179 is placed on the flexible sheet 196, the flexible sheet 196 can accommodate inaccuracy of the parallelism of the upper surface 191a of the stage 191 and the lower surface 193a of the pusher 193. Thus, the respective same amounts of the photo-curing resin can be stably pushed into the nozzle holes 8.

Next, as shown in FIG. 13A, the carrier sheet 176 is removed from the nozzle plate 30. Then, as shown in FIG. 13B, a light such as an ultraviolet light or a laser light is applied to the upper surface 31 of the nozzle plate 30, so that a first portion 161a of the photo-curing resin that is pushed in each of the nozzle holes 8 and a second portion 161b of the resin that is continuous with the first portion 161a and is aligned with, and located outside, the each nozzle hole 8 are irradiated by the light and are cured. This is a curing step. Only the first and second portions 161a, 161b of the photo-curing-resin sheet 175 can be cured by adjusting an amount or intensity of the light applied to the nozzle plate 30. Thus, a columnar or cylindrical cured portion 162 including first and second cured portions 162a, 162b is formed. The cylindrical cured portion 162 projects outward from the ejection outlet 8a of each nozzle hole 8, and has the same diameter as that of the ejection outlet 8a. In the above-described pushing step, dust is prevented from entering each nozzle hole 8. Therefore, in the curing step, the light is prevented from being irregularly diffused by the dust that might be present in the each nozzle hole 8, and accordingly the cylindrical cured portion 162 having the same diameter as that of the ejection outlet 8a is formed. Thus, the respective cylindrical cured portions 162 corresponding to the plurality of nozzle holes 8 have the uniform shape and size.

Then, as shown in FIG. 13C, a portion of the photo-curing-resin sheet 175 that has not been cured by the light, i.e., an uncured portion of the sheet 175 other than the columnar cured portions 162 is dissolved in a developing liquid, and is removed from the lower surface 70a of the nozzle plate 30. Thus, only the columnar cured portions 162 are held by the nozzle holes 8, such that the cured portions 162 project outward from the respective ejection outlets 8a of the nozzle holes 8. This is a removing step. Thus, the first portion, i.e., base-end portion 162a of each columnar cured portion 162 is left in one end portion of the straight portion 101 of the corresponding nozzle hole 8, such that the base-end portion 162a clogs or fills the end portion of the straight portion 101. In this state, as shown in FIG. 13C, the lower surface 70a of the nozzle plate 30 is coated with a water-repellent layer 106, e.g., a nickel plating containing a fluoric high polymer material such as polytetrafluoroethylene. Thus, as shown in FIG. 13C, the water-repellent layer 106 having a substantially uniform thickness is formed on the lower surface 70a of the nozzle plate 30. This is a water-repellent-layer forming step. Subsequently, as shown in FIG. 13D, after the formation of the water-repellent layer 106, the columnar cured portions 162 are dissolved in a stripping liquid, and thereby removed from the nozzle plate 30. Each columnar cured portion 162 partially projects outward from the ejection outlet 8a of the corresponding nozzle 8, and has the same diameter as the inner diameter of the ejection outlet 8a. Therefore, when each columnar set portion 162 is removed from the nozzle plate 30, then a hole 106a is formed or left in the water-repellent layer 106 such that the hole 106a is accurately aligned with the ejection outlet 8a of the corresponding nozzle 8 and has the same cross-section area as that of the corresponding ejection outlet 8a. Thus, the water-repellent layer 106 is formed along the ejection outlet 8a of each nozzle hole 8. In the above-described treating method, the water-repellent layer 106 is formed on the nozzle sheet 30.

As is apparent from the foregoing description of the present method of treating the nozzle plate 30, the laminated body 179 is placed in the air-tight space (i.e., ambient space) 198, and the air pressure in the space 198 is lowered. Since the air pressure is lowered, the glass transition temperature of the photo-curing-resin sheet 175 is lowered. In this state, the respective portions of the photo-curing resin of the sheet 175 are pushed into the nozzle holes 8. In the present embodiment, if the environment in which the pushing step is carried out, i.e., the decompressing and pushing apparatus 190 is kept at an appropriate temperature, for example, a room temperature, the respective appropriate amounts of the photo-curing resin of the sheet 175 can be pushed into the nozzle holes 8, without heating the photo-curing resin. Therefore, air bubbles are not produced in the respective portions of the photo-curing resin that are located around the respective ejection outlets 8a of the nozzle holes 8, and accordingly the columnar cured portions 162 can have respective stable shapes. Thus, in the water-repellent-layer forming step, the nozzle plate 30 is coated with the water-repellent layer 106 having the desirable holes 106a each of which has the same shape and size as those of the ejection outlet 8a of the corresponding nozzle hole 8. Therefore, droplets of the ink can be ejected by each nozzle 8 in a stable direction. Moreover, in the pushing step, the laminated body 179 need not be heated. Thus, even if the respective thermal contraction coefficients (i.e., respective linear thermal expansion coefficients) of the nozzle plate 30 and the photo-curing-resin sheet 175 may differ from each other, the nozzle plate 30 is not warped. Even if the laminated body 179 may be heated up to the temperature range of from 20° C. to 30° C., as described above, that temperature range corresponds to the room-temperature range or level. Therefore, the nozzle plate 30 is not warped by the difference of the respective thermal contraction coefficients of the nozzle plate 30 and the photo-curing-resin sheet 175.

While the present invention has been described in its preferred embodiment, it is to be understood that the present invention may be embodied in different manners.

For example, in the illustrated embodiment, the nozzle plate 30 is for use in the line-type ink-jet recording head 1. However, the principle of the present invention is applicable to a nozzle plate for use in a serial-type ink-jet recording head. In addition, each nozzle hole 8 formed in the nozzle plate 30 may have a different shape. For example, each nozzle hole may be defined by only a straight hole that is formed through the thickness of the nozzle plate 30 such that the cross-sectional shape (e.g., circular shape) of the straight hole is constant over the thickness. Alternatively, each nozzle hole may be defined by only a tapered hole that is formed through the thickness of the nozzle plate 30 such that the diameter of the tapered hole continuously decreases in a direction from the upper surface of the plate 30 toward the lower surface of the same 30.

In the illustrated embodiment, the two nip rollers 171, 172 of the laminating device 170 cooperate with each other to adhere the photo-curing-resin sheet 175 and the carrier sheet 176 to each other while sandwiching the nozzle plate 30 therebetween. However, it is not needed to use the carrier sheet 176. In addition, it is not needed to use the laminating device 175 for the purpose of adhering the photo-curing-resin sheet 175 to the lower surface 70a (i.e., the ink ejection surface) of the nozzle plate 30. In this case, it is desirable to adhere the photo-curing-resin sheet 175 to the nozzle plate 30, without producing wrinkles of the sheet 175, for the purpose of preventing air from being trapped between the two elements 175, 30. In addition, when the nozzle plate 30 is nipped by the two nip rollers 171, 172, the plate 30 may be moved relative to the rollers 171, 172 such that each of the lengthwise and widthwise directions of the plate 30 is angled with respect to the respective axis lines of the rollers 171, 172 and such that the nip length over which the plate 30 is nipped by the rollers 171, 172 is smaller than the length of the plate 30, i.e., the dimension thereof in the lengthwise direction thereof In this case, too, the difference of the respective pressing forces of the two nip rollers 171, 172 applied to the widthwise opposite end portions of the nip length of the nozzle plate 30 can be more or less reduced. Therefore, air can be prevented from being trapped by, and between, the nozzle plate 30 and the photo-curing-resin sheet 175 and by, and between, the nozzle plate 30 and the carrier sheet 176, and accordingly wrinkles can be prevented from being produced in the two sheets 175, 176. Meanwhile, in the case where there is substantially no difference of the respective pressing forces of the two nip rollers 171, 172 applied to the widthwise opposite end portions of the nip length of the nozzle plate 30, the nozzle plate 30 may be nipped by the two nip rollers 171, 172 such that the nip length of the plate 30 is greater than the length of the plate 30. In each case, the time duration needed for the nozzle plate 30 to pass through the two nip rollers 171, 172 can be shortened, and accordingly the efficiency of the laminating step can be increased.

In the illustrated embodiment, the pushing step is carried out such that the laminated body 179 is sandwiched by the two parallel surfaces, i.e., the lower surface 193a of the pusher (i.e., flat plate) 193 and the upper surface 191a of the stage (i.e., flat plate) 191, so that the respective portions of the photo-curing resin of the sheet 175 are pushed into the nozzle holes 8. However, the pusher 193 and the stage 191 may be replaced by two rollers, and the laminated body 179 may be nipped by the two rollers under a lowered air pressure so that the photo-curing-resin sheet 175 is pressed against the nozzle plate 30 and the respective portions of the photo-curing resin are pushed into the nozzle holes 8. In addition, in the illustrated embodiment, the flexible sheet 196 is provided on the stage 191. However, in the case where it is reliably assured that the lower surface 193a of the pusher (i.e., flat plate) 193 and the upper surface 191a of the stage (i.e., flat plate) 191 are parallel to each other, it is not needed to provide the flexible sheet 196 on the stage 191.

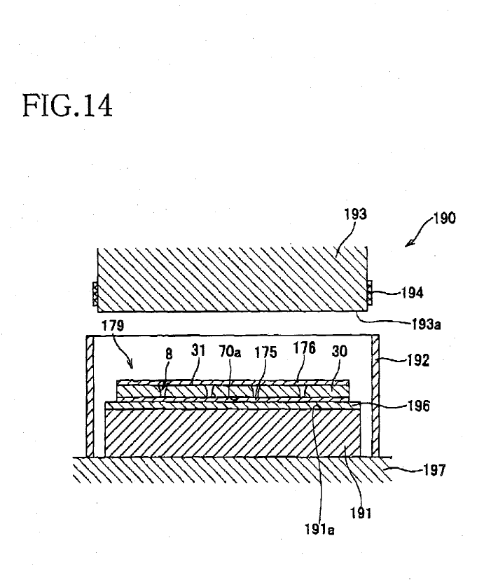

In the illustrated embodiment, as shown in FIG. 12A, the laminated body 179 is placed in the decompressing and pressing device 190, such that the photo-curing-resin sheet 175 is opposed to the lower surface 193a of the pusher 193. However, as shown in FIG. 14, the laminated body 179 may be placed in the decompressing and pressing device 190, such that the carrier sheet 176 is opposed to the lower surface 193a of the pusher 193. In this case, the photo-curing-resin sheet 175 is held in contact with the flexible sheet 196, and is pressed. Therefore, even if the lower surface 193a of the pusher 193 may have some irregularities and apply locally different pressing pressures to the laminated body 179, the entirety of the photo-curing-resin sheet 175 can receive a substantially uniform pressure from the flexible sheet 196. In addition, even if the lower surface 70a of the nozzle plate 30 may have some irregularities, the photo-curing-resin sheet 175 can receive a substantially uniform pressure because of the elastic deformation of the flexible sheet 196. Thus, it is reliably assured that the respective uniform amounts of the photo-curing resin are pushed into the nozzle holes 8, irrespective of where the nozzle holes 8 are located in the nozzle plate 30.

It is to be understood that the present invention may be embodied with other changes and improvements that may occur to a person skilled in the art, without departing from the spirit and scope of the invention defined in the claims.

What is claimed is:

1. A method of treating a nozzle plate having at least one nozzle hole which is formed through a thickness thereof and an ejection surface in which one of opposite open ends of said at least one nozzle hole opens, a droplet of a liquid being ejected from said one open end of said at least one nozzle hole, the method comprising
providing, on the ejection surface of the nozzle plate, a layer of a photo-curing resin, such that the layer of the photo-curing resin closes at least said one open end of said at least one nozzle hole,
pressing, in a state in which a pressure of a: gas in an ambient space around the nozzle plate is lower than an atmospheric pressure, the layer of the photo-curing resin against the nozzle plate, and causing a first portion of the photo-curing resin to be pushed into one of opposite end portions of said at least one nozzle hole through said one open end thereof,
irradiating, with a light through an other of the opposite end portions of said at least one nozzle hole, the first portion of the photo-curing resin pushed in said one end portion of said at least one nozzle hole, and a second portion of the photo-curing resin that is continuous with the first portion thereof and is aligned with, and located outside, said one open end of said at least one nozzle hole, so as to cure the first and second portions,
removing an uncured, remaining portion of the photo-curing resin so as to expose the ejection surface of the nozzle plate such that the cured first and second portions of the photo-curing resin are held by said at least one nozzle hole, and
forming a water-repellent layer on the exposed ejection surface of the nozzle plate.

2. The method according to claim 1, wherein said providing comprises superposing, on the ejection surface of the nozzle plate, a sheet of the photo-curing resin as the layer of the photo-curing resin.

3. The method according to claim 1, wherein said providing comprises providing, as the layer of the photo-curing resin, a layer of an acrylic photo-curing resin.

4. The method according to claim 1, wherein said providing comprises providing the layer of the photo-curing resin whose thickness is not greater than a diameter of said one open end of said at least one nozzle hole.

5. The method according to claim 2, wherein said superposing comprises superposing the sheet of the photo-curing resin on the nozzle plate, by nipping, with two nip rollers, the nozzle plate and the sheet of the photo-curing resin.

6. The method according to claim 5, wherein said superposing comprises superposing the sheet of the photo-curing resin on the nozzle plate, by nipping, with the two nip rollers, the nozzle plate, the sheet of the photo-curing resin, and a carrier sheet, such that the carrier sheet cooperates with the sheet of the photo-curing resin to sandwich the nozzle plate.

7. The method according to claim 5, wherein said superposing comprises nipping, with the two nip rollers, the nozzle plate and the sheet of the photo-curing resin, such that a nip length that is defined, in a direction parallel to respective axis lines of the two nip rollers, as a length of a portion of the nozzle plate that is nipped by the two nip rollers, is smaller than a maximum dimension of the nozzle plate in a lengthwise direction thereof.

8. The method according to claim 1, wherein said pressing comprising applying a pressing force to at least one of two flat plates which cooperate with each other to sandwich the nozzle plate and the layer of the photo-curing resin, so that the first portion of the photo-curing resin is pushed into said one end portion of said at least one nozzle hole.

9. The method according to claim 1, wherein said pressing comprising keeping a temperature of the nozzle plate and the layer of the photo-curing resin, to a temperature range of from 20° C. to 30° C.

10. The method according to claim 8, wherein said pressing comprising providing a flexible sheet between the nozzle plate and one of the two flat plates.

11. The method according to claim 9, wherein said pressing comprising keeping the pressure of the gas in the ambient space around the nozzle plate, to a value which is lower than the atmospheric pressure and assures that when the layer of the photo-curing resin is pressed against the nozzle plate in the temperature range of from 20° C. to 30° C., the first portion of the photo-curing resin is pushed into said one end portion of said at least one nozzle hole.

12. The method according to claim 1, wherein said pressing comprising keeping the pressure of the gas in the ambient space around the nozzle plate, to not higher than 1,500 Pa.

13. The method according to claim 1, wherein said pressing comprising pressing, for a predetermined time duration, the layer of the photo-curing resin against the nozzle plate, so that a predetermined amount of the first portion of the photo-curing resin is pushed into said one end portion of said at least one nozzle hole.

14. The method according to claim 13, wherein said predetermined time duration is not shorter than 10 seconds.

15. The method according to claim 13, wherein said predetermined time duration is not longer than 3 minutes.

16. The method according to claim 13, wherein said pressing comprising pressing, with a predetermined pressing pressure, the layer of the photo-curing resin against the nozzle plate, and wherein the predetermined pressing pressure falls in a range of from 2.8×10⁵ Pa to 6.9×10⁶ Pa.

17. The method according to claim 13, wherein said pressing comprising pressing, with a pressing pressure of from 2.8×10⁵ Pa to 8.3×10⁵ Pa and for a time duration of from 2 minutes to 3 minutes, the layer of the photo-curing resin against the nozzle plate.

18. The method according to claim 13, wherein said pressing comprising pressing, with a pressing pressure of from 4.2×10⁶ Pa to 6.9×10⁶ Pa and for a time duration of from 10 seconds to 1 minute, the layer of the photo-curing resin against the nozzle plate.

19. A method of producing a nozzle plate, the method comprising
preparing a nozzle plate having at least one nozzle hole which is formed through a thickness thereof, and an ejection surface in which one of opposite open ends of said at least one nozzle hole opens, a droplet of a liquid being ejected from said one open end of said at least one nozzle hole,
treating the nozzle plate by the method according to claim 1.

20. A method of producing an ink-jet recording head, the method comprising
preparing a flow-channel unit which includes the nozzle plate treated by the method according to claim 1 and has at least one flow channel including at least one pressure chamber which communicates with said at least one nozzle hole and supplies an ink to said at least one nozzle hole,
preparing an actuator which changes a pressure of the ink in said at least one pressure chamber so as to eject a droplet of the ink from said at least one nozzle hole, and
assembling the flow-channel unit and the actuator with each other so as to provide the ink-jet recording head.
